(19) United States
(12) Patent Application Publication
(10) Pub. No.: US 2006/0078652 A1
(43) Pub. Date: Apr. 13, 2006

(54) Multi-flavored ice cream cone

(76) Inventor: Rhudy Frederick Phillips, Fayetteville, NC (US)

Correspondence Address: Mr. Rhudy F. Phillips, 2410 Murchison Road, Fayetteville, NC, 28301, US

(21) Appl. No.: 10/963,914

(22) Filed: Oct. 13, 2004

(51) Int. Cl. A23G 9/00

(52) U.S. Cl. 426/101

(57) ABSTRACT

A process for adding a desired singular food flavor such as a raspberry or strawberry or a combination of desired food flavors such as a banana nut, butter pecan, peanut-butter fudge or the like to the batter that is used to make ice cream cones for the purpose of producing a flavored ice cream cone to enhance the flavor and eating enjoyment of the product.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to an edible container commonly referred to as an ice cream cone or sugar cone and is used to hold ice cream for the purpose of eating the ice cream without aid of a spoon. Ice cream cones in the past have been found to be very bland in taste so as not to take away from the flavor of the ice cream which has always been the real prize of this delicious refreshing treat. More specifically, the invention relates to adding food flavoring to the batter of the ice cream cone so that the cone now has a distinct and flavorful taste of it's own Examples: Banana Nut, Chocolate Chip, Butter Pecan, etc.

### BRIEF SUMMARY OF THE INVENTION

This invention provides a method of mixing desirable food flavors directly into the batter of the ice cream cone either singularly such a raspberry or collectively such as banana nut, prior to it being placed or injected into a mold for the purpose of forming the varied shapes available today. With this done, an individual now may order a scoop of vanilla ice cream and have it served in a butter pecan cone and enjoy a much more flavorful treat. Many combinations avail.

### BRIEF DESCRIPTION OF THE SEVERAL VIEWS OF THE DRAWING

NOT APPLICABLE

### DETAILED DESCRIPTION OF THE INVENTION

The method of manufacturing the multi-flavored ice cream cone according to this invention involves first, the selection of the flavor(s) that are to be incorporated in to the dough. Then when the preparation of a creamy cohesive batter is finished, (current recipes are acceptable) the adding of the selected flavor(s) by mixing them into the batter followed by a combination of sequential steps of molding and baking the dough to ultimately produce the specifically improved taste of a multi-flavored ice cream cone.

I claim:

1. A process of mixing desirable food flavor(s) directly into the cohesive batter of that which would commonly be used to make ice cream cones for the purpose of making a flavored ice cream cone.
